(19) United States
(12) Patent Application Publication
(10) Pub. No.: US 2013/0340797 A1
(43) Pub. Date: Dec. 26, 2013

(54) CLOTHES TREATMENT APPLIANCE WITH TRANSFER PIPE

(71) Applicants: Ralf Bömmels, Falkensee (DE); Bernd Gemünden, Deisenhofen (DE); Jürgen Heß, Berlin (DE); Vladimir Proseanic, West Bloomfield, MI (US); Svetlana Visnepolschi, West Boomfield, MI (US)

(72) Inventors: Ralf Bömmels, Falkensee (DE); Bernd Gemünden, Deisenhofen (DE); Jürgen Heß, Berlin (DE); Vladimir Proseanic, West Bloomfield, MI (US); Svetlana Visnepolschi, West Boomfield, MI (US)

(73) Assignee: BSH BOSCH UND SIEMENS HAUSGERÄTE GMBH, Munich (DE)

(21) Appl. No.: 13/532,880

(22) Filed: Jun. 26, 2012

(51) Int. Cl. B08B 3/04; D06F 39/00

(52) U.S. Cl. 134/34; 134/104.1

(57) ABSTRACT

A clothes treatment appliance includes a transfer pipe leading to a water-cleanable unit of the clothes treatment appliance. The transfer pipe includes a water diverter that diverts part of the water exiting the transfer pipe in a sideway direction. A method for cleaning a water-cleanable unit of a clothes treatment appliance includes releasing water into a transfer pipe and diverting part of the water exiting the transfer pipe in a sideway direction.

### BACKGROUND OF THE INVENTION

The invention relates to a clothes treatment appliance, in particular a clothes dryer, including a transfer pipe leading to a water-cleanable unit of the clothes treatment appliance.

A typical condensation-type clothes dryer (as such or as a washer-dryer in combination with a washing function) includes a laundry or clothes container (e.g. a rotatable clothes drum) that is connected to an air inlet and an air outlet of a process air channel. Warm air entering the clothes container via the air inlet of the process channel dries the clothes or laundry. The resulting warm and wet process air leaves the clothes container through the air outlet of the process air channel and flows to a process air condenser that cools the process air. At the condenser, the humidity contained by the process air precipitates. Thus, behind the condenser (with respect to a flow direction of the process air) the process air is cool and dry and flows to a heater which heats up the process air to be warm and dry. This warm and dry process air is then re-introduced into the clothes container via the air inlet. To keep up the flow of the process air, an air blower may be used.

During the drying process, solid residues, especially fluff and hair, are released by the clothes and are dragged along with the process air. At the condenser, the fluffs and hair etc. adhere to the precipitated drops of condensate water and at least partly stick to the condenser if the water drops drip from the condenser, typically into a condensate collection unit like a collection pan. To remove particles from the process air prior to the condenser, it is known to place filters into the process air channel between the air outlet and the condenser. However, filters are not effective enough to separate all the particles or residue from the process air flow. Therefore, at the condenser mainly agglomerated lint (from fluff and/or hairs) can be observed even after a few drying operations. These lint agglomerations reduce the condensation effectiveness and may cause a breakdown of the condenser function over time.

For this sake, the condensation unit is going to be cleaned by rinsing in appropriate sequences. In state of the art appliances the removal of the agglomerations is realized by issuing a water gush where the water is released from a water container above the condenser and flows through a downpipe that directs the water to the condenser. The downpipe is typically formed as a vertically aligned, linear pipe with an outlet in form of an opening at its lower end. By letting water into the downpipe (typically through an inlet located or formed at its upper end) the water runs down the downpipe and creates the water gush at an (lower) outlet of the downpipe. The water gush has a high momentum in the vertical direction to remove even tightly adhering residue.

For example, EP 2 134 896 B1 and WO 2010/102892 A1 both disclose a cleaning device as described with the water container in an upper region of the drying appliance and the condenser in a lower region of the drying appliance. The water container is supplied by condensate water collected from the condenser.

However, the water gush often cannot completely clean the condenser, and typically a certain amount of lint remains. One reason is that the condenser has a large footprint or area while the downpipe typically has a significantly smaller diameter.

It is one possibility to clean a larger area of the condenser by placing the downpipe higher with respect to the condenser and thus create a wider water gush by the lateral, unrestricted expansion of the water flowing through the air. However, this greatly reduces the momentum of the water hitting the condenser and thus its ability to effectively remove sticky residue.

Another way to clean a larger area of the condenser comprises submerging the condenser in water and applying ultrasound to the water. However, implementation of this cleaning method is rather complex.

### BRIEF SUMMARY OF THE INVENTION

It is an object of the present invention to overcome or mitigate at least some of the problems associated with the prior art and in particular to provide a relatively simple clothes treatment appliance with an improved effectiveness for cleaning a water-cleanable unit, in particular condenser.

An object is achieved by a clothes treatment appliance, including a transfer pipe leading to a water-cleanable unit of the clothes treatment appliance, wherein the transfer pipe includes at least one water diversion means that is adapted to divert at least part of the water exiting the transfer pipe in a sideway direction. The diverted water hits the condenser in areas next to the region that would be cleaned by non-diverted water. This enlarges the area or region of the water-cleanable unit that can be effectively cleaned. There is no need for a large distance between the transfer pipe and the water-cleanable unit such that a high momentum of water can be maintained the water. Also, using the water diversion means enables a precisely formed and directed water gush. It is an additional advantage that the sideway direction lets the water gush hit the lint in a direction differently from the vertical direction of condensate running down the condenser which enables a more effective removal of this lint.

The transfer pipe may in particular be a downpipe in the broad sense that it is aligned vertically over practically its full length but may alternatively have, at least in parts, a different orientation, e.g. be sloped or inclined or even be oriented horizontally at least in parts or sections. The transfer pipe may even be oriented upwards, e.g. in the case that the liquid to be transferred through the transfer pipe is pressurized.

The sideways direction may in particular mean a direction that specifically or systematically differs from the direction of the water gush without using the water diversion means. In particular, the sideways direction may be a direction inclined to the longitudinal direction of the transfer pipe at the outlet. In particular, the sideways direction may be a direction inclined to the longitudinal axis of the transfer pipe, in particular inclined to a vertical direction. In particular, the sideways direction may be a direction inclined to the main flow direction of the water gush, which main flow direction may in particular be a direction of highest flow rate.

For a particular strong effect, the water diversion means may extend up to or reach an outlet of the transfer pipe. In particular, the water diversion means may for or be the outlet of the transfer pipe. In particular, the water diversion means maybe an attachment of the transfer pipe.

It is an embodiment that the at least one water diversion means includes or is a loose end section of the transfer pipe. Thus, the end section includes at least one outlet of the transfer pipe. A loose end section may in particular be an end section that changes its form, e.g. bends, in a non-deterministic or random manner. The form change leads to a changing position and direction of the at least one outlet. Thus the direction of the water gush changes frequently and the water directly hits the water-cleanable unit over a wide area. The form change may be caused by the water running in the transfer pipe.

It is an embodiment thereof that the loose end section includes a flexible end section, e.g. made from soft (elastomeric) plastics. The flexible end section may have a pipe-like form and may be attached to a rigid part of the transfer pipe. The water running in the transfer pipe may cause the flexible end section to flap around.

It is also an embodiment that the at least one water diversion means includes a sprinkler-type head. The sprinkler-type head may in particular include one or more lateral outlet openings or outlets. The sprinkler-type head may also include a central (vertical) outlet. The sprinkler-type head may be a fixed head or a rotating head (that rotates when water flows through it).

It is another embodiment that the at least one water diversion means includes a Coanda-shaped end section. The Coanda-shaped end section is adapted to create a Coanda effect that adds lateral momentum to the water gush by diverting water on or next to a (typically convex) Coanda surface of the end section. This enables a precisely widened water gush of high momentum.

In an embodiment thereof the Coanda-shaped end section includes at least one Coanda-shaped shell. This enables a particular easy implementation. The Coanda-shaped shell is, in other words, a shell that enables the Coanda effect. The Coanda-shaped shell may in particular be a shell-shaped ring. The shell-shaped ring may have a convex inner wall, e.g. by bending a flat ring to the inside.

In another embodiment thereof the Coanda-shaped end section includes a vibrating or fast-moving Coanda-shaped end section. This further increases lateral momentum of the water gush. To cause the vibration, the Coanda-shaped end section may in particular comprise at least two oscillating Coanda-shaped bodies, in particular shells, e.g. sectional shells like two half-shells or four quarter-shells. In this case, the vibration is thus an oscillation of several bodies (here: shells). However, the vibrating Coanda-shaped end section is not thus limited and may e.g. comprise a deformation means to elastically deform at least one Coanda-shaped body, in particular shell. In particular, a bending radius of the inner wall (Coanda surface) may thus be varied.

It is still another embodiment that at least one water diversion means includes a spiraling water guidance structure at its inner wall. This adds rotational momentum to water running down the inner wall so that this water is directed more sideways or outwardly than without the spiraling water guidance structure. The spiraling water guidance structure is particularly easy to implement, e.g. by providing one or more spiraling grooves at an inner wall of the transfer pipe, in particular at the end section. The one or more spiraling grooves may in particular be helical grooves.

The water-cleanable unit may e.g. include or be a condenser (in particular process air condenser) and/or a lint (fluff, hair etc.) filter within a process air channel. Such a lint filter or process air filter may be positioned between a clothes container (e.g. drum) of the clothes treatment appliance and the condenser. The condenser may e.g. be embodied as a water/air heat exchanger. Alternatively, the condenser may be an evaporator of a heat pump, e.g. of a compressor-type heat pump.

An inlet of the transfer pipe may be connected to a water container and/or be connected to a water tap or water connection, e.g. a fresh-water tap. The water container is particularly positioned above the water-cleanable unit such that water released into the transfer pipe can create a water gush at a lower outlet of the transfer pipe to clean the water-cleanable unit.

Up to now, the energy and momentum of the water is mainly dependent on the gravitational potential energy on the water and thus on the height of the water container. To increase, in particular amplify, the energy and momentum of the water leaving the transfer pipe and thus to enhance a cleaning effectiveness in particular with respect to the water-cleanable unit, the clothes treatment appliance may further comprise at least one water acceleration means. The water acceleration means also enables a shorter transfer pipe and thus a more flexible design and/or a more compact set-up.

It is one variation that the at least one water acceleration means includes at least one pressure generation means for generating pressure in the transfer pipe. The pressure increases the energy and momentum of the water leaving the transfer pipe. The pressure generation means may have a particularly simple and rugged design or set-up. Also, use of the pressure generation means enables a fast-responding build-up (and relaxation) in pressure of the water and thus a precise control of the water momentum and energy.

It is one variation thereof that the at least one pressure generation means includes an inlet for a pressurized medium. This enables a particularly simple set-up. The pressure of the pressurized medium is transferred to the water coming from the water container. The pressurized medium may e.g. be pressurized process air tapped or bypassed from a process air channel, pressurized air generated by a compressor, steam provided by a steam generator, main (tap) water and/or water output by a pump.

In one variation, the inlet is connected to the pressure generation means to drive the pressure generation means. In this case the pressure generation means could also be called a pressure transfer means.

In another variation, the inlet is directly connected to the transfer pipe to directly transfer the pressure to the transfer pipe. In particular if the inlet is directly connected to the transfer pipe, the pressure generator unit providing the pressurized medium may be part of the pressure generation means, e.g. a valve connected to a tap or main water line, an air compressor, a steam generator and so on.

It is yet another variation that an outlet of the transfer pipe is shaped as a Venturi nozzle that is connected to the inlet for the pressurized medium. Thus, the pressurized medium accelerates the water having flown through the transfer pipe. The Venturi nozzle may e.g. be integrated into the transfer pipe or may be an attachment to an existing transfer pipe. For example alternatively, the transfer pipe may have a nozzle/nozzle-like means at another position, e.g. in a midsection. The Venturi nozzle may be regarded as a pressure generation means. The Venturi nozzle may e.g. be embodied as a loose end section of the transfer pipe, may have a Coanda-shaped inner wall that creates the Coanda effect and/or may comprise a spiraling water guidance structure etc.

It is even another variation that the at least one pressure generation means includes a compression chamber connected to the transfer pipe downstream a valve for controlling a water flow from the water container into the transfer pipe and wherein the compression chamber includes a mechanical means for controllably changing a volume of the compression chamber. This enables a particular high pressure.

The mechanical means may e.g. include a piston or a deformable membrane. The membrane may be made of rubber etc. The piston may be pushed in the direction of the transfer pipe to reduce the volume available for the water e.g. by pressure (pressured air, steam or water). In this case the compression chamber may be regarded as a pressure transfer means. The membrane may in particular be pushed in the direction of the transfer pipe by pressure to reduce the volume available for the water e.g. by pressure (pressured air, steam or water).

Alternatively, the mechanical means may be moved or driven by a motor (electric motor, linear drive, hydraulic motor and so on), in particular if the mechanical means is a piston.

It is a variation thereof that the compression chamber is a section of the transfer pipe. This enables an easy assembly and particularly compact design.

It is generally advantageous that the pressure generation means is connected to the transfer pipe downstream (with respect to the water coming from the water container) a valve for controlling a water flow from the water container into the transfer pipe. This prevents a spill-back of the water into the water container and enables to maintain the pressure in the transfer pipe if this valve is closed. To adjust activation of the valve and the water acceleration means, the clothes treatment appliance may e.g. comprise a control means (for example a microcontroller) for controlling the valve and the water acceleration means.

Generally, the valve may be a controlled/active valve or be a passive valve like a flap or a back-pressure valve etc.

The valve may e.g. be integrated with an outlet of the water tank, be located between the water tank and the transfer pipe or be integrated with the transfer pipe.

It is yet another variation that the pressure generation means includes a steam generator for generating steam as the pressurized medium and wherein a steam outlet of the steam generator is connected to the transfer pipe downstream a valve for controlling a water flow from the water container into the transfer pipe. The use of a steam generator may enable a particularly compact design. The steam generator may include an electric heater.

To feed the electric heater with water, it may be connected to the transfer pipe, in particular at a position of the transfer pipe below the connection to its steam outlet. This has the advantage that the steam generator does not need a separate water feed and may produce pressurized steam if there is water in the transfer pipe but does not generate steam if the transfer pipe is empty.

It is yet another variation that the at least one water acceleration means includes at least one propeller situated within the transfer pipe. The rotation of the propeller pushes the water in the direction of the outlet of the transfer pipe. Use of the propeller has the advantage that this embodiment allows for a particularly compact design.

It is another variation that the clothes treatment appliance is adapted to apply a water hammer effect on water in the transfer pipe. The water hammer effect may in particular include a modulation of the pressure of the water leaving the transfer pipe. The modulation may in particular include a series of pressure pulses or spikes, in particular a periodic series. The water hammer effect enhances the cleaning effectiveness even further.

It is one variation thereof that the water hammer effect is achieved by modulating a pressure generated by the at least one pressure generation means.

It is another variation thereof that the transfer pipe includes a closing means downstream the water acceleration means for periodically opening and closing the transfer pipe. Thus, the closing means may generate the series of pressure pulses or spikes in a simple manner.

In particular, the closing means may include a rotating chopper. The rotating chopper may be rotatable by a motor.

In one variation thereof, the rotating chopper has a cylinder-shaped body which has a through-hole perpendicular to its longitudinal axis. By placing the section of the chopper that includes the through-hole within the transfer pipe and by rotating the chopper around its longitudinal axis, the through-hole is alternatingly aligned parallel to the transfer pipe (and then fully opens the transfer pipe) and perpendicular to the transfer pipe (and then closes the transfer pipe). The longitudinal axis of the chopper may in particular be oriented perpendicular to a longitudinal axis of the transfer pipe, e.g. horizontally. This embodiment has the advantage that the chopper has a fixed position with respect to the down pipe which simplifies a pressure-tight sealing. The chopper may be fixed to the transfer pipe by a pivot bearing.

In another variation thereof, the rotating chopper has a disc-shaped body (‘rotor’) which has one or more through-holes parallel to its longitudinal axis. If there is more than one through-hole, they are advantageously located concentrically around a longitudinal axis of the chopper. By placing a section of the rotor that includes at least one through-hole into a cut-out of the transfer pipe and by rotating the rotor around its longitudinal axis, the at least one through-hole is alternatingly placed within the transfer pipe (and then opens the transfer pipe) or outside the transfer pipe (such that the chopper closes the transfer pipe). It is advantageous that a distance between the through-holes is such that the transfer pipe is alternatingly opened and closed by the rotation rotor. Advantageously, the plane of the disc-shaped rotor (perpendicular to the longitudinal axis) is oriented perpendicular to the longitudinal axis of the transfer pipe, e.g. horizontally, and the longitudinal axis is oriented parallel to the longitudinal axis of the transfer pipe.

In yet another variation thereof, the chopper has two disc-shaped bodies, both of which have one or more through-holes. The two disc-shaped bodies may in particular have the same or a very similar shape and a same location and size of the through-hole. Of the two disc-shaped bodies, at least one body is rotatable (‘rotor’), or e.g. both bodies are rotatable but in a different direction. This chopper may be placed within the transfer pipe. During operation, the through-holes of the two discs alternatingly overlap or are misaligned and thus leave the transfer pipe open or close the transfer pipe, respectively.

The clothes treatment appliance may in particular be a clothes drying appliance, e.g. a clothes dryer or a washer-dryer.

The clothes treatment appliance may in particular be a household appliance.

An object is also achieved by a method for cleaning a water-cleanable unit of a clothes treatment appliance, the method at least including the following steps: (i) releasing water into a transfer pipe and (ii) diverting part of the water exiting the transfer pipe in a sideway direction.

It is an embodiment thereof that the diverting step includes bending an end section of the transfer pipe by means of the water in the end section.

It is another embodiment thereof that the diverting step includes diverting the part of the water by means of the Coanda effect.

It is yet another embodiment thereof that the diverting step includes adding a rotational movement to at least part of the water in the transfer pipe.

The method may further be varied, in particular in analogy to the clothes treatment appliance.

### BRIEF DESCRIPTION OF THE DRAWINGS

In the following drawings, the invention is schematically described in more detail by means of several embodiments. Same or functionally equivalent elements may be denoted by the same reference signs.

FIG. 1 shows a sectional side view of a household drying appliance including a water acceleration means;

FIG. 2 shows a sectional side view of a transfer pipe including a water diversion means in form of a loose end section;

FIG. 3 shows a sectional side view of a transfer pipe including a water diversion means in form of a rigid Coanda-shaped end section;

FIG. 4 shows a sectional side view of a transfer pipe including a water diversion means in form of a vibrating or oscillating Coanda-shaped end section; and

FIG. 5 shows a sectional side view of a transfer pipe including a water diversion means in form of a spiraling water guidance structure;

FIG. 6 shows a sectional side view of one embodiment of the water acceleration means;

FIG. 7 shows a sectional side view of another embodiment of the water acceleration means;

FIG. 8 shows a sectional side view of yet another embodiment of the water acceleration means;

FIG. 9 shows a sectional side view of even another embodiment of the water acceleration means;

FIG. 10 shows a sectional side view of a chopper for creating a water hammer effect; and

FIG. 11 shows a bottom view of another chopper for creating a water hammer effect.

### DETAILED DESCRIPTION OF EXEMPLARY EMBODIMENTS OF THE PRESENT INVENTION

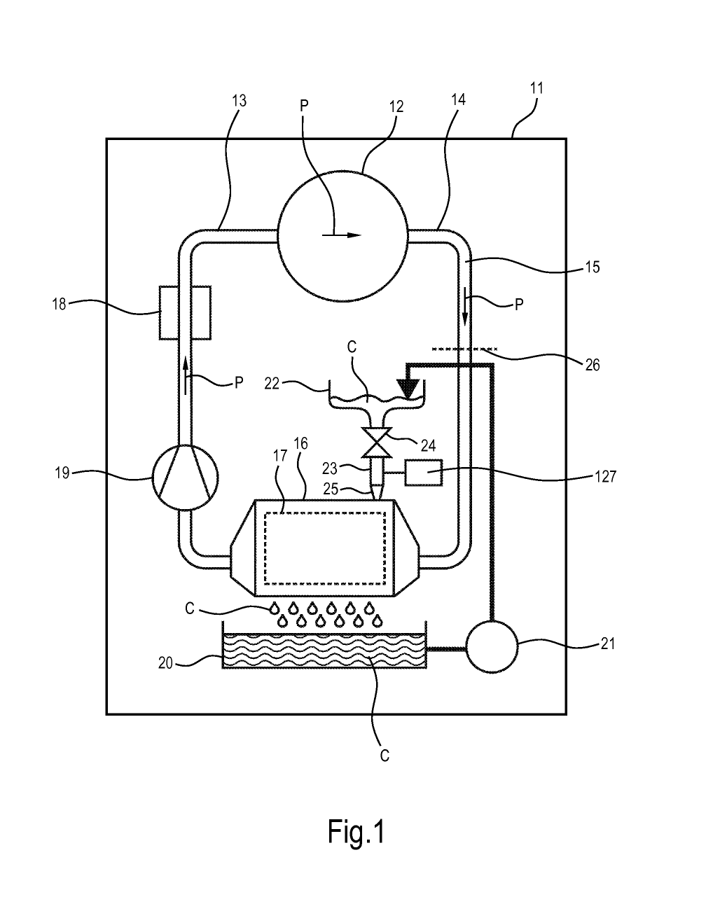

FIG. 1 shows a clothes treatment appliance realized as a household drying appliance 11, in particular a clothes dryer. The drying appliance 11 comprises a clothes container in form of a rotatable clothes drum 12. The drum 12 is connected to an air inlet section 13 and an air outlet section 14 of a process air channel 15. Warm air entering the drum 12 via the air inlet section 13 can dry the clothes contained in the drum 12. The resulting warm and wet process air P leaves the drum 12 through the air outlet section 14 and flows to a process air condenser 16 that cools the process air P. Thus, at the condenser 16, the process air P precipitates. To cool the process air P, the condenser 16 has several plate-like cooling blades 17 that are arranged in a parallel fashion (which in the shown drawing are oriented in parallel to and are spaced apart perpendicular to the viewing plane).

The condenser 16 and its cooling blades 17, respectively, may be water-cooled. In this case, the condenser may be embodied as a water/air heat exchanger. Alternatively, the process air condenser 16 may be an evaporator of a heat pump, e.g. a compressor-type heat pump.

Behind or downstream the condenser 16, the process air P is cool and dry and flows to a heater 18 that heats up the process air P to be warm and dry. The heater 18 may be, e.g., an electric heater or a condenser of a heat pump.

This warm and dry process air P is then re-introduced into the drum 12 via the air inlet section 13. To keep up the flow of the process air P, an air blower 19 is used.

To collect the condensate C dripping from the condenser 16, underneath there is located a condensate collection unit 20, e.g. a pan. The condensate collection unit 20 may be integrated in the process air channel 15, e.g. as a bottom of a section of the process air channel 15. From the condensate collection unit 20, the condensate C is pumped by a pump 21 to a water container 22 located above the condenser 16. A bottom region of the water container 22 is connected to a transfer pipe 23 that leads to the condenser 16. In this particular embodiment, the transfer pipe 23 is a downpipe. Between the water container 22 and the transfer pipe 23 is a controllable valve 24 that, if opened, allows the condensate C stored in the water container 22 to enter an upper inlet of the transfer pipe 23 and flow through the transfer pipe 23. A lower end of the transfer pipe is formed as a water diversion means 25. The water leaves the water diversion means 25 as a water gush G. The transfer pipe 23 is directed such that the water gush G can clean the condenser 16, in particular cooling blades of the condenser 16. The condenser 16 is thus a water-cleanable unit.

Alternatively or additionally, the water-cleanable unit may e.g. be a process air filter 26, in particular if positioned between the drum 12 and the condenser 16.

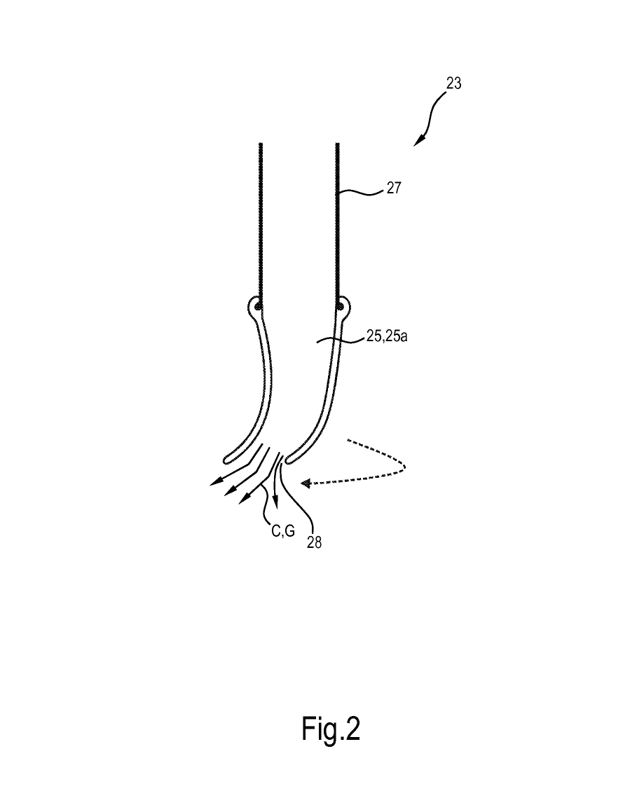

FIG. 2 shows a sectional side view of the transfer pipe 23 comprising a water diversion means 25 in form of a loose end section 25a. The loose end section 25a is embodied as a flexible, soft attachment to a rigid, pipe-shaped main body 27 of the transfer pipe 23. The loose end section 25a comprises one central outlet 28 through which the condensate C exits in form of a water gush G. When the condensate C flows through the loose end section 25a, the loose end section 25a bends in a non-deterministic or random manner, i.e. flaps around. This leads to a changing position and direction of the outlet 28 and thus to a diversion of at least part of the condensate C in a sideways direction.

The loose end section 25a also has a pipe-like form. In its relaxed state with no condensate C running through it, the loose end section 25a may be a straight pipe or a bent Pipe.

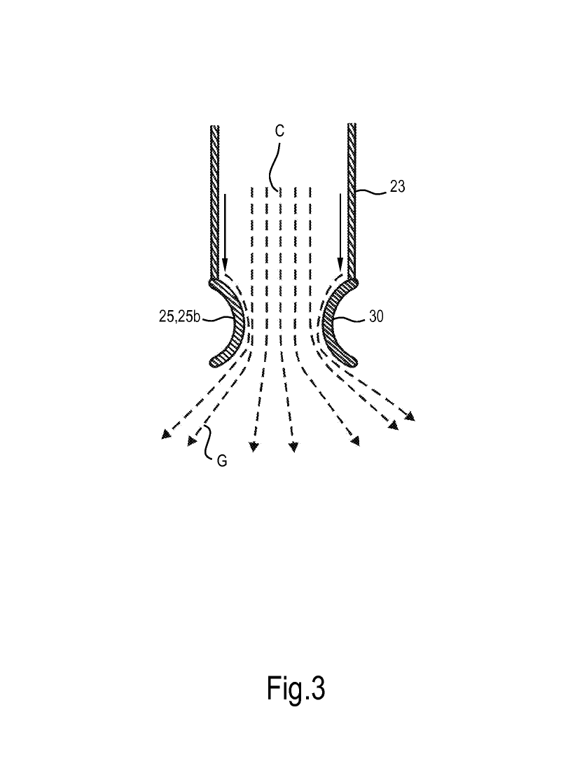

FIG. 3 shows a sectional side view of a transfer pipe 23 comprising a water diversion means 25 in form of a rigid Coanda-shaped end section 25b. The Coanda-shaped end section 25b is adapted to create a Coanda effect that adds lateral momentum to the water gush G/condensate C by diverting the condensate C on or next to a (typically convex) Coanda surface 29 of the end section 25b. This enables a precisely widened water gush G of high momentum. The Coanda-shaped end section 25b comprises one ring-like Coanda-shaped shell 30 or shell-like (in particular integral) section of the transfer pipe. This enables a particular easy implementation.

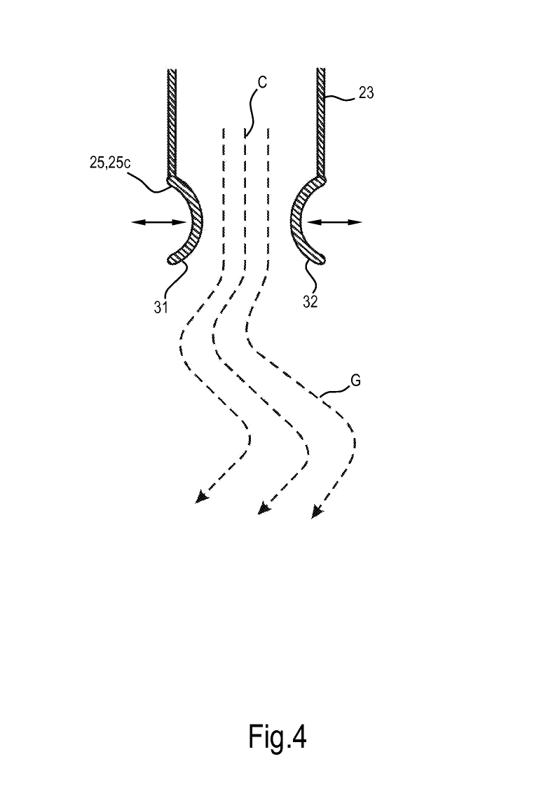

FIG. 4 shows a sectional side view of a transfer pipe 23 comprising a water diversion means 25 in form of an oscillating Coanda-shaped end section 25c. The Coanda-shaped end section 25c comprises at least two opposing sectional Coanda shells 31, 32 that can be vibrated or oscillated in a direction against each other. This further increases the lateral momentum of the condensate C or water gush G and causes a wider directional variety of the water gush G which both leads to a more effective cleaning.

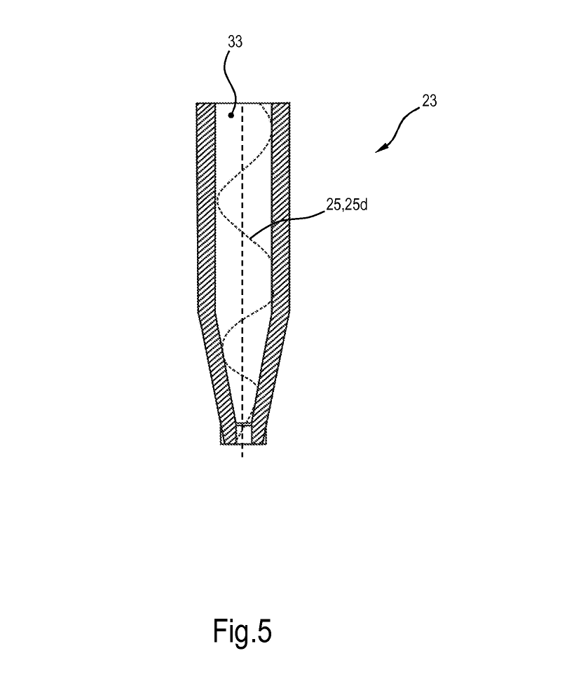

FIG. 5 shows a sectional side view of a transfer pipe 23 comprising a water diversion means 25 in form of a spiraling water guidance structure 25d in form of at least one spiraling or helical groove formed within an inner wall 33 of the transfer pipe 23.

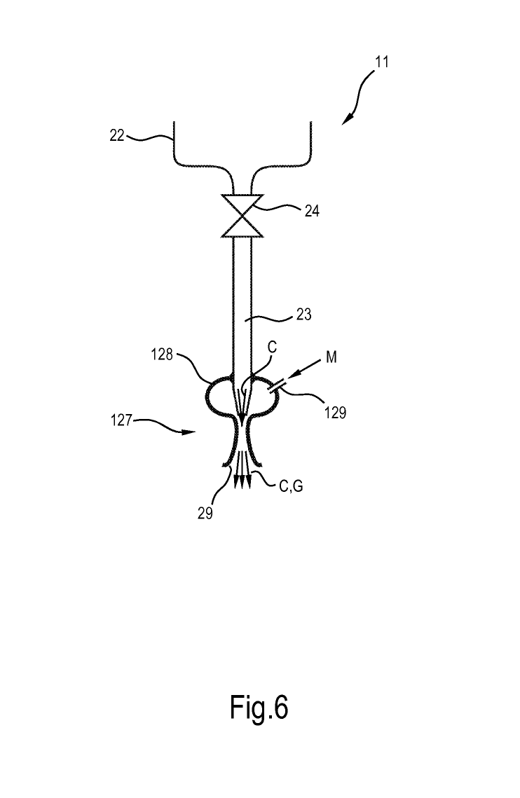

FIG. 6 shows a sectional side view of one embodiment of a water acceleration means 127 that may be part of the household drying appliance 11 to further enhance cleaning efficiency. The water acceleration means 127 includes a Venturi nozzle 128 at the outlet section of the transfer pipe 23. The Venturi nozzle 128 comprises an inlet 129 for pressurized medium M, e.g. pressurized air or water. The pressurized medium M is used in a well-known manner to create the Venturi effect and to accelerate the condensate C leaving the transfer pipe 23. The Venturi nozzle 128 may be integrated into the transfer pipe 23 or may be an attachment to the transfer pipe 23. The water acceleration means 127 also has a Coanda surface 29 to widen the water gush G.

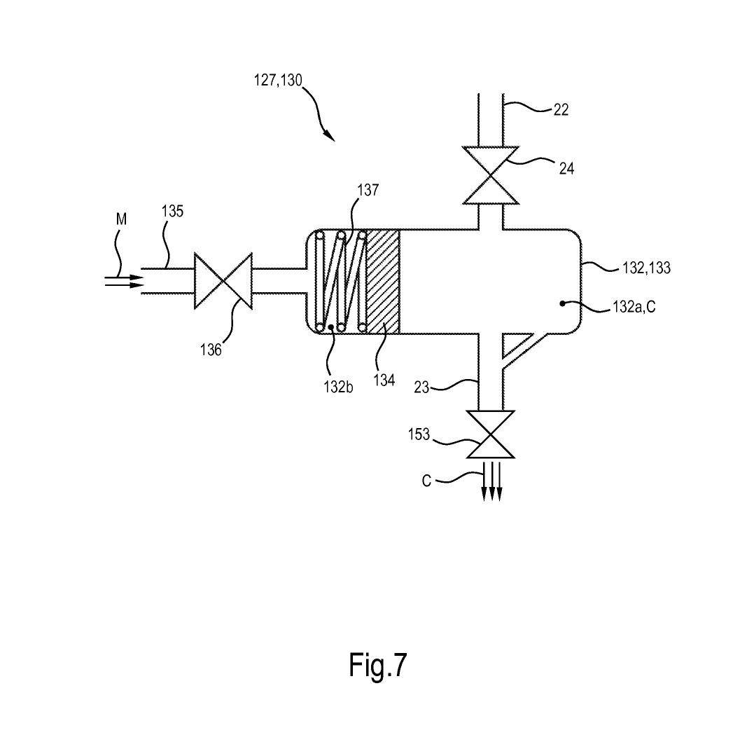

FIG. 7 shows a sectional side view of another embodiment of the water acceleration means 127. Here, the water acceleration means 127 includes a pressure generation means 130 for generating pressure in the transfer pipe 23 by a compression chamber 132. The compression chamber 132 is located downstream the valve 24 and is realized as a section 133 of the transfer pipe 23. The compression chamber 132 is divided into two parts 132a, 132b, namely a first part 132a containing the condensate C coming from the water container 22 and a second part 132b not comprising the condensate C. The compression chamber 132 further comprises a mechanical means in form of a movable piston 134 that acts as a partition means for the two parts 132a and 132b. Movement of the piston 134 controllably changes a volume of the compression chamber 132 (in particular its first part 132a). This enables a particular high pressure of the condensate C within the transfer pipe 23. To this effect, the second part 132b comprises an inlet 135 for pressurized medium M that can be opened and closed by a valve 136. To increase the pressure and to facilitate a movement of the piston 134 in the direction of the first part 132a (to decrease its volume), a spring 137 is located in the second part 132b that pushes the piston 134 in the direction of the first part 132a.

During one possible mode of operation, the valve 24 opens and lets the condensate C flow into the transfer pipe 23. When the valve 24 closes, the valve 136 opens such that the second part 132b is pressurized (e.g. by an influx of pressurized process air P or tap water) and moves the piston 134 in the direction of the first part 132a. This reduces a volume of the first part 132a and increases pressure of the condensate C.

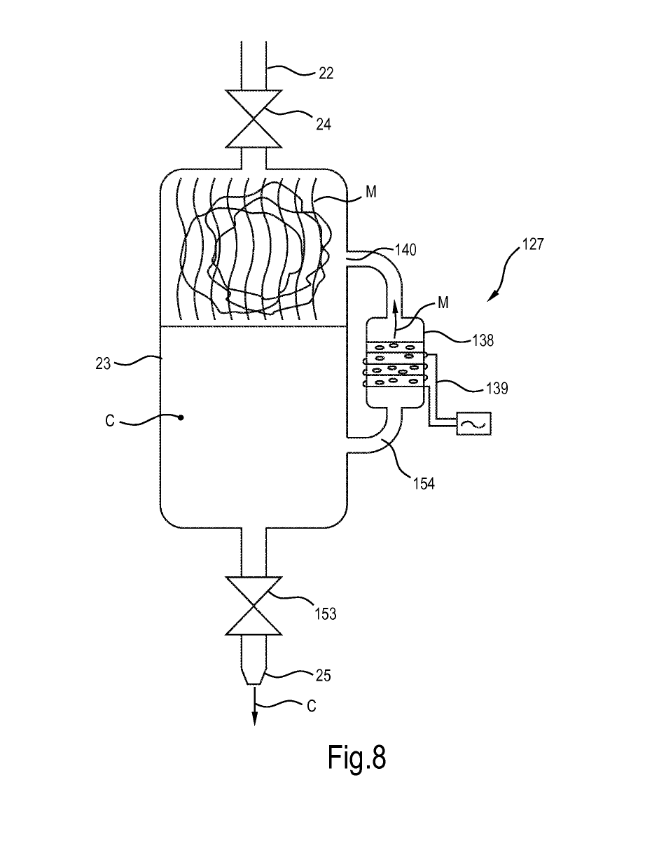

The transfer pipe 23 may have another valve 153 (see FIG. 8 in analogy) downstream the compression chamber 132. During the above mentioned mode of operation, the valve 153 may in particular be closed if the valve 24 opens and the piston 134 is moved to achieve a fast filling of the first part 132a with the condensate C to be able to increase pressure in the first part 132a.

During another possible mode of operation, the valve 153 is closed when the valve 24 is open and may open after the valve 136 has opened and the piston 134 has been moved, or a little later or earlier. Therefore, the piston 134 acts on a contained condensate C that cannot leave the transfer pipe 23 during pressure build-up.

Generally, the compression chamber 132, in particular its first part 132a, and the water container 22 may be or may be merged as one unit.

FIG. 8 shows a sectional side view of yet another embodiment of the water acceleration means 127 including a steam generator 138 as a pressure generating means for generating steam as the pressurized or pressurizing medium. The steam generator 138 includes an electric heater 139, an outlet of which is connected to a steam inlet 140 for the steam. The steam inlet 140 is also located downstream the valve 24. The transfer pipe 23 also shows the valve 153 downstream the inlet 140 for the steam.

In one mode of operation, the valve 24 is open to feed the condensate C into the transfer pipe 23 while the valve 153 is closed. An opening duration of the valve 24 is such that a water level of the condensate C filling the transfer pipe 23 is lower than the inlet 140 for the steam. Then the valve 24 is closed such that the transfer pipe 23 provides a pressure-tight container for the condensate C. In a further step, the electric heater 139 is activated and generates steam as the pressurizing medium M. The steam builds up in the transfer pipe 23 and generates pressure. In a next step, the valve 153 is opened, and the condensate C can leave the transfer pipe 41 with increased pressure via the water diversion means 25. After that, the process may be repeated.

To feed the electric heater 139 with water, it is connected by a feed channel 154 to the transfer pipe 23, at a position below the inlet 140 and below the water level. Thus, the steam generator 138 does not need to have a separate water feed and may only produce pressurized steam M if there is condensate C in the transfer pipe 23.

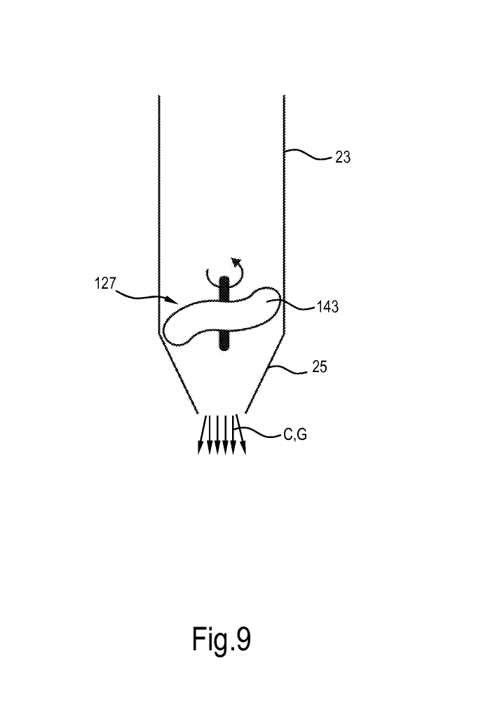

FIG. 9 shows a sectional side view of another embodiment of the water acceleration means 127 including a propeller 143 situated within the transfer pipe 23. The rotation propeller 143 pushes the condensate C in the direction of the water diversion means 25 of the transfer pipe 23.

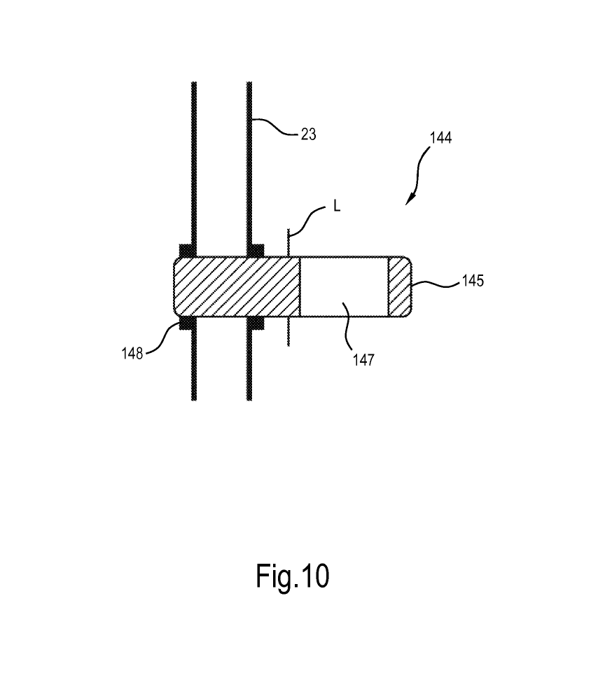

FIG. 10 shows a sectional side view of a rotating chopper 145 for creating a water hammer effect. The rotating chopper 145 is part of a closing means 144 for periodically opening and closing the transfer pipe 23. Thus, the closing means 144 may generate a series of pressure pulses or spikes of the pressure of the condensate C leaving the transfer pipe 23 in a simple manner.

The rotating chopper 145 has a disc-shaped body (‘rotor’) which has one or more through-holes 147 perpendicular to its longitudinal axis L. If there is more than one through-hole 147, they are located concentrically around the longitudinal axis L. By placing a section of the chopper 145 that comprises at least one through-hole 147 into a cut-out 148 of the transfer pipe 23 and by rotating the chopper 145 around its longitudinal axis L, the at least one through-hole 147 is alternatingly placed within the transfer pipe 23 (and then opens the transfer pipe 23) or outside the transfer pipe 23 (such that the chopper 145 closes the transfer pipe 23). To allow a large opening cross section, a diameter of the at least one through-hole 147 may correspond to a diameter of the transfer pipe 23 at the cut-out 148, or may be slightly smaller to increase a sealing property.

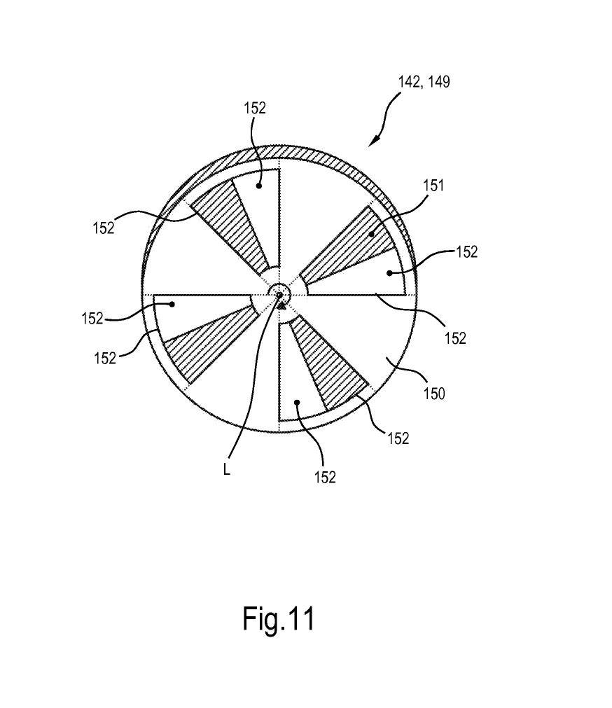

FIG. 11 shows a bottom view of a closing means 142 including another chopper 149 for creating a water hammer effect. This chopper 49 has two disc-shaped bodies 150 and 151. The bodies 150 and 151 are concentrically aligned and are only shown offset for easier description of the chopper 149. The bodies 150 and 151 are of the same shape and have several through-holes 152. The through-holes 152 are shaped like angular sectors of a ring. Of the two disc-shaped bodies 150 and 151, only one body 150 or 151 is rotatable.

This chopper 149 is placed within the transfer pipe. During rotation, the through-holes 152 of the bodies 150 and 151 alternatingly overlap and are misaligned and thus open or close the transfer pipe, respectively.

Of course, the present invention is not limited to the described embodiments.

What is claimed is:

1. A clothes treatment appliance, comprising:
a transfer pipe leading to a water-cleanable unit of the clothes treatment appliance,
wherein the transfer pipe includes a water diverter that is adapted to divert part of the water exiting the transfer pipe in a sideway direction.

2. The clothes treatment appliance according to claim 1, wherein the water diverter comprises a loose end section.

3. The clothes treatment appliance according to claim 2, wherein the loose end section comprises a flexible end section.

4. The clothes treatment appliance according to claim 1, wherein the water diverter comprises a Coanda-shaped end section.

5. The clothes treatment appliance according to claim 4, wherein the Coanda-shaped end section comprises a Coanda-shaped shell.

6. The clothes treatment appliance according to claim 5, wherein the Coanda-shaped end section comprises a vibrating Coanda-shaped end section.

7. The clothes treatment appliance according to claim 6, wherein the Coanda-shaped end section comprises at least two oscillating Coanda-shaped shells.

8. The clothes treatment appliance according to claim 1, wherein the water diverter comprises a spiraling water guidance structure at an inner wall.

9. The clothes treatment appliance according to claim 1, wherein the water-cleanable unit is a process air condenser.

10. The clothes treatment appliance according to claim 1, wherein an inlet of the transfer pipe is connected to a water tank.

11. The clothes treatment appliance according to claim 1, wherein the clothes treatment appliance further comprises a water accelerator to accelerate the water in the transfer pipe.

12. A method for cleaning a water-cleanable unit of a clothes treatment appliance, the method comprising:
releasing water into a transfer pipe; and
diverting part of the water exiting the transfer pipe in a sideway direction.

13. The method according to claim 12, wherein diverting part of the water comprises bending an end section of the transfer pipe by means of the water in the end section.

14. The method according to claim 12, wherein diverting part of the water comprises diverting the part of the water by means of the Coanda effect.

15. The method according to claim 12, wherein diverting part of the water comprises adding a rotational movement to part of the water in the transfer pipe.
